(19) United States
(12) Patent Application Publication
(10) Pub. No.: US 2013/0157917 A1
(43) Pub. Date: Jun. 20, 2013

(54) Industrial cleaning compositions and methods for using same

(71) Applicants: David Fluck, Elkton, MD (US); Amit Sehgal, Marlton, NJ (US); Charles Aymes, Monmouth Junction, NJ (US)

(72) Inventors: David Fluck, Elkton, MD (US); Amit Sehgal, Marlton, NJ (US); Charles Aymes, Monmouth Junction, NJ (US)

(73) Assignee: Rhodia Operations, Cranbury, NJ (US)

(21) Appl. No.: 13/374,272

(22) Filed: Dec. 20, 2011

(51) Int. Cl. C11D 3/60

(52) U.S. Cl. 510/109

(57) ABSTRACT

An environmentally-friendly cleaning composition for use in paper processing or recycling, which comprises in one embodiment (a) a blend of dibasic esters, (b) one or more biodiesel components (c) and, optionally, water or an additional component. The dibasic esters can be derived from a blend of adipic, glutaric, and succinic diacids, or isomers of adipic acid.

### CROSS-REFERENCE TO RELATED APPLICATIONS

This application claims the benefit of International Application Number PCT/US2010/001996, filed on Jul. 16, 2010 and published as International Publication No. WO 2011/008289, which claims the benefit of U.S. Provisional Application No. 61/271,058, filed on Jul. 16, 2009, all herein incorporated by reference.

### FIELD OF THE INVENTION

This invention relates to cleaning compositions that are environmentally friendly, biodegradable, non-toxic and non-flammable with low odor, low vapor pressure and low volatile organic compound (VOC) content and, more particularly, cleaning compositions utilized for multiple commercial and industrial applications, including in the paper and printing industry.

### DESCRIPTION OF RELATED ART

Many commercially available cleaners utilize volatile organic compounds in cleaning. Compounds which are high VOC solvents include toluene, xylene, methyl ethyl ketone, glycol ethers, tetrachloroethylene, methyl isobutyl ketone, methanol, 1,1,1-trichloroethane, dichloromethane and ethylene glycol. These and other high VOC solvents are used for cleaning the presses, rollers and other equipment in various industries including the paper and printing industries. Further, many current cleaning compositions contain aromatic groups that are in many cases toxic, have unpleasant odors, and are not environmentally friendly in that they do not biodegrade well. Often these solvents will be low vapor pressure solvents with low flashpoints that are also extremely flammable. Such compositions are undesirable in light of the increased awareness for human exposure to toxic materials and the demand for environmentally friendly cleaners.

Because many solvents are flammable, toxic to health, and/or have unpleasant odors there is a need to develop provide an improved cleaning composition and methods of use which is environmentally friendly and effective, in particular with respect to the printing and paper industries.

### SUMMARY OF THE INVENTION

In one aspect, disclosed are cleaning compositions used in industrial paper processing applications. When paper is recycled, significant quantities of non-pulp material, such as, resins, inks, polymers, adhesives, etc. are removed and separated from the pulp-material. The pulp material finds its way to the sheet production end of the paper making process. It is at this process that the pulp is formed into a continuous sheet on a conveyer-type arrangement, which typically is a nylon mesh belt know as the “wires” (because in the early papermaking process brass wires made up the conveyer surface). The wires are open mesh such that water can be squeezed from the pulp as the sheet is formed. By removing bulk water before drying significant quantities of energy and water can be saved as well as maintaining sheet consistency. One drawback, however, is that the mesh may clog with residual materials from the recycling process and needs to be cleaned in situ in order to prevent shut down of the papermaking process. Shut down is highly undesirable because it will disrupt the sheet which is difficult to remake. Therefore, the mesh needs to be cleaned during the process using an appropriate solvent that will dissolve the offending materials (typically under a high pressure sprayer). The cleaning composition was shown to perform equivalent to the a current industrial paper processing solvent, Hi Sol 70R™. It is believed that Hi Sol 70R™ is an aromatic blend, which is environmentally unfriendly, that imparts a strong kerosene odor to the paper. The cleaning composition is more efficient at removing material from the screens yet is still environmentally friendly.

The invention as claimed will become apparent from the following detailed description and examples, which comprises in one aspect, is a cleaning composition comprising one or more dibasic esters; one or more biodiesel components; and optionally additional components and/or water. The dibasic esters can be derived from adipic, glutaric, and succinic diacids, or isomers thereof. In one particular embodiment, the dibasic ester blend is comprised of a mixture dialkyl methylglutarate, dialkyl ethylsuccinate and dialkyl adipate. In another particular embodiment, the dibasic ester blend is comprised of a mixture dialkyl methylglutarate and dialkyl ethylsuccinate. In one aspect, the cleaning composition comprises (a) a blend of dibasic esters comprising dialkyl methylglutarate and at least one of dialkyl adipate and dialkyl ethylsuccinate, typically the blend comprises a mixture of dialkyl adipate, dialkyl methylglutarate and dialkyl ethylsuccinate; and (b) a biodiesel component, typically one or a mixture of fatty acid alkyl esters.

The biodiesel component can be one or a mixture of fatty acid alkyl esters. In one embodiment, the fatty acid alkyl esters include but are not limited to: methyl, ethyl, propyl, butyl and/or stearyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and the technical mixtures thereof.

The cleaning composition has desirable qualities including one or a combination of being: substantially non-toxic, non-flammable, biodegradable, high flash point, low vapor pressure and low odor; meets the consumer products LVP-VOC exemption criteria established by CARB and federal VOC exemption from EPA. Typically, a low VOC product, depending on the class of product, has less than 50 g/L VOC, or in some cases less than 100 g/L VOC, or in some cases less than 150 g/L VOC.

In another aspect, one embodiment of the invention is a cleaning composition comprising, based on the total weight of the composition: (a) from about 1% to about 99% by weight a blend of dibasic esters; (b) from about 1% to about 95% by weight one or more biodiesel components; and optionally, (c) water and/or additional components. The addition components include but are not limited to surfactants, for example anionic surfactants, cationic surfactants, amphoteric surfactants, zwitterionic surfactants, nonionic surfactants and any combination thereof, as well as fragrances and solubilizers, pH adjusting agents, whiteners, delaminates such as pinenes, for example, d-limonene, opacifying agent, anti-corrosion agents, anti-foaming agents, coloring agents, stabilizers and thickeners. The cleaning composition can be used in a variety of commercial and/or industrial applications.

In another aspect, disclosed is a cleaning composition comprising: from about 25% to about 95% by weight a blend of dibasic esters; from about 1% to about 75% by weight a biodiesel component; and, optionally, water or additional components; more typically, from about 50% to about 90% by weight a blend of dibasic esters; from about 1% to about 50% by weight a biodiesel component; and, optionally, (c) water or an additional component. In another embodiment, the cleaning composition further comprises about 1% to about 25% by weight an additional component. Optionally, can be added. The cleaning composition can be provided as a liquid or spray formulation for use, depending upon the application.

In a further aspect, the cleaning composition comprises a blend of alkyl esters of adipic, glutaric, and succinic diacids or a blend of alkyl esters of adipic, methylglutaric and ethylsuccinic diacids. The cleaning composition can be used as an paper screen/press/roller cleaner comprising: (a) from about 1% to about 95%, by weight of the cleaning composition, a blend of dibasic esters, wherein the blend comprises:

(i) about 7-14%, by weight of the blend, a diester of formula:

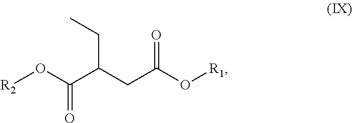

(ii) about 80-94%, by weight of the blend, a diester of formula

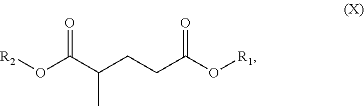

and

(iii) about 1-5% (by weight of the blend) a diester of formula

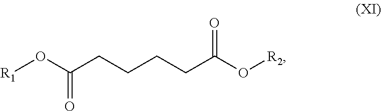

wherein R₁ and/or R₂ individually comprise a hydrocarbon having from about 1 to about 8 carbon atoms, typically, methyl, ethyl, propyl, isopropyl, butyl, isobutyl, n-butyl or isoamyl; (b) from about 1% to about 50%, by weight of the cleaning composition, a biodiesel component; (c) from about 0% to about 12%, by weight of the cleaning composition, one or more additional components, and (d) from about 0% to about 85%, by weight of the cleaning composition, water.

The cleaning composition is environmentally friendly, with a high flash point, low vapor pressure and low odor; it falls under the consumer products LVP-VOC exemption criteria established by CARB and federal VOC exemption from EPA. The cleaning formulation has environmentally friendly characteristics including but not limited to being non toxic, bio-degradable, non-flammable and the like. This formulation can be applied as a cleaning composition.

### BRIEF DESCRIPTION OF DRAWINGS

FIG. 1 is a chart illustrating solvent cleaning effectiveness on nylon mesh.

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cᵣ-Cₛ)” in reference to an organic group, wherein r and s are each integers, indicates that the group may contain from r carbon atoms to s carbon atoms per group.

As used herein, the terminology “surfactant” means a compound that when dissolved in an aqueous medium lowers the surface tension of the aqueous medium.

The invention as claimed is a cleaning composition comprising a blend of dibasic esters. In one embodiment, the blend comprises adducts of alcohol and linear diacids, the adducts having the formula R₁—OOC-A-COO—R₂ wherein R₁ and/or R₂ comprise, individually, a C₁-C₁₂ alkyl, more typically a C₁-C₈ alkyl, and A comprises a mixture of —(CH₂)₄—, —(CH₂)₃, and —(CH₂)₂—. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms.

In one embodiment, the blend comprises adducts of alcohol and branched or linear diacids, the adducts having the formula R1-OOC-A-COO—R₂ wherein R₁ and/or R₂ comprise, individually, a C₁-C₁₂ alkyl, more typically a C₁-C₈ alkyl, and A comprises a mixture of —(CH₂)₄—, —CH₂CH₂CH(CH₃)—, and —CH₂CH(C₂H₅)—. In another embodiment, R₁ and/or R₂ comprise, individually, a C₄-C₁₂ alkyl, more typically a C₄-C₈ alkyl. It is understood that the acid portion may be derived from such dibasic acids such as adipic, succinic, glutaric, oxalic, malonic, pimelic, suberic and azelaic acids, as well as mixtures thereof.

One or more dibasic esters used in the invention as claimed can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

The dibasic esters can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention).

The dibasic esters may be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”).

In one embodiment, the blend of esters is derived from by-products in the reaction, synthesis and/or production of hexamethylenediamine utilized in the production of polyamide, typically polyamide 6,6. The cleaning composition comprises a blend of dialkyl esters of adipic diacids, methylglutaric diacids, and ethylsuccinic diacids (herein referred to sometimes as “MGA”, “MGN”, “MGN blend” or “MGA blend”).

The boiling point of the dibasic ester blend is between the range of about 120° C. to 450° C. In one embodiment, the boiling point of the blend is in the range of about 160° C. to 400° C.; in one embodiment, the range is about 210° C. to 290° C.; in another embodiment, the range is about 210° C. to 245° C.; in another embodiment, the range is the range is about 215° C. to 225° C. In one embodiment, the boiling point range of the blend is between about 210° C. to 390° C., more typically in the range of about 280° C. to 390° C., more typically in the range of 295° C. to 390° C. In one embodiment, boiling point of the blend is in the range of about 215° C. to 400° C., typically in the range of about 220° C. to 350° C.

In one embodiment, the blend of dibasic esters has a boiling point range of between about 300° C. and 330° C. Typically, the diisoamyl AGS blend is associated with this boiling point range. In another embodiment, the dibasic ester blend has a boiling point range of between about 295° C. and 310° C. Typically, the di-n-butyl AGS blend is associated with this boiling point range. Generally, a higher boiling point, typically, above 215° C., or high boiling point range corresponds to lower VOC.

The dibasic esters or blend of dibasic esters are incorporated into a cleaning composition which, in one embodiment, comprises (a) a blend of dialkyl esters of adipic, glutaric, and succinic diacids or a blend of dialkyl esters of adipic, methylglutaric, and ethylsuccinic diacids; (b) a biodiesel component; and, optionally, (c) water or one or more additional components. The additional components in some embodiments are surfactants, for example a cationic, anionic, nonionic, amphoteric and/or zwitterionic surfactant.

In one embodiment, the nonionic surfactants generally includes one or more of for example amides such as alkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid and mixtures thereof.

In another embodiment, the non-ionic surfactant is a glycol such as polyethylene glycol (PEG), alkyl PEG esters, polypropylene glycol (PPG) and derivatives thereof. In one embodiment, the surfactant is an alcohol ethoxylate, an alkyl phenol ethoxylate or a terpene alkoxylate. In one exemplary embodiment, the surfactant is a C₆-C₁₃ alcohol ethoxylate and, more typically, a C₈-C₁₂ alcohol ethoxylate.

In another embodiment, the surfactant is a cationic surfactant. The cationic surfactant includes but is not limited to quaternary ammonium compounds, such as cetyl trimethyl ammonium bromide (also known as CETAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl distearyldimonium chloride, dicetyl dimonium chloride, stearyl octyldimonium methosulfate, dihydrogenated palmoylethyl hydroxyethylmonium methosulfate, isostearyl benzylimidonium chloride, cocoyl benzyl hydroxyethyl imidazolinium chloride, dicetyl dimonium chloride and distearyldimonium chloride; isostearylaminopropalkonium chloride or olealkonium chloride; behentrimonium chloride; as well as mixtures thereof.

In another embodiment, the surfactant is an anionic surfactant. The anionic surfactant includes but is not limited to linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, sulfosuccinates, isethionates, and taurates, as well as mixtures thereof. Commonly used anionic surfactants that are suitable as the anionic surfactant component of the composition include, for example, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium-monoalkyl phosphates, sodium dialkyl phosphates, sodium lauroyl sarcosinate, lauroyl sarcosine, cocoyl sarcosine, ammonium cocyl sulfate, ammonium lauryl sulfate, sodium cocyl sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium lauryl sulfate, potassium cocyl sulfate, potassium lauryl sulfate, monoethanolamine cocyl sulfate, sodium tridecyl benzene sulfonate, and sodium dodecyl benzene sulfonate. Branched anionic surfactants are particularly preferred, such as sodium trideceth sulfate, sodium tridecyl sulfate, ammonium trideceth sulfate, ammonium tridecyl sulfate, and sodium trideceth carboxylate.

Any amphoteric surfactant that is acceptable for use includes but is not limited to derivatives of aliphatic secondary and tertiary amines in which the aliphatic radical can be straight chain or branched and wherein one of the aliphatic substituents contains from about 8 to about 18 carbon atoms and one contains an anionic water solubilizing group. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

Suitable zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, amidopropyl betaines, and alkyl sultaines, such as cocodimethyl sulfopropyl betaine, stearyldimethyl sulfopropyl betaine, lauryl dimethyl sulfoethyl betaine, lauryl bis-(2-hydroxy-ethyl)sulfopropyl betaine, and alkylamidopropylhydroxy sultaines.

In one embodiment, the cleaning composition comprises (a) a blend of about 70-90% dialkyl dimethylglutarate, about 5-30% dialkyl ethylsuccinate and about 0-10% dialkyl adipate; (b) a biodiesel component comprising one or more fatty acid alkyl esters and (d) water. Each alkyl substituent of the blend is individually chosen from a hydrocarbon group containing from about 1 to 8 hydrocarbons such as methyl or ethyl, propyl, isopropyl, butyl, n-butyl or pentyl, or iso-amyl groups. Optionally, one or more additives or additional components such as surfactants, delaminating agents, buffering and/or pH control agents, fragrances, opacifying agents, anti-corrosion agents, whiteners, defoamers, dyes, sudsing control agents, stabilizers, thickeners and the like can be added to the composition.

According to one embodiment, the blend of dibasic esters corresponds to one or more by-products of the preparation of adipic acid, which is one of the main monomers in polyamides. For example, the dialkyl esters are obtained by esterification of one by-product, which generally contains, on a weight basis, from 15 to 33% succinic acid, from 50 to 75% glutaric acid and from 5 to 30% adipic acid. As another example, the dialkyl esters are obtained by esterification of a second by-product, which generally contains, on a weight basis, from 30 to 95% methyl glutaric acid, from 5 to 20% ethyl succinic acid and from 1 to 10% adipic acid. It is understood that the acid portion may be derived from such dibasic acids such as, adipic, succinic, glutaric, oxalic, malonic, pimelic, suberic and azelaic acids, as well as mixtures thereof.

In some embodiments, the dibasic ester blend comprises adducts of alcohol and linear diacids, the adducts having the formula R—OOC-A-COO—R wherein R is ethyl and A is a mixture of —(CH₂)₄—, —(CH₂)₃, and —(CH₂)₂—. In other embodiments, the blend comprises adducts of alcohol, typically ethanol, and linear diacids, the adducts having the formula R¹—OOC-A-COO—R², wherein at least part of R¹ and/or R² are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH₂)₄—, —(CH₂)₃, and —(CH₂)₂—.

In another embodiment, the R¹ and/or R² groups can be linear or branched, cyclic or noncyclic, C₁-C₂₀ alkyl, aryl, alkylaryl or arylalkyl groups. Typically, the R¹ and/or R² groups can be C₁-C₈ groups, for example groups chosen from the methyl, ethyl, n-propyl, isopropyl, n-butyl, n-amyl, n-hexyl, cyclohexyl, 2-ethylhexyl and isooctyl groups and their mixtures. For example, R¹ and/or R² can both or individually be ethyl groups, R¹ and/or R² can both or individually be n-propyl groups, R¹ and/or R² can both or individually be isopropyl groups, R¹ and/or R² can both or individually be n-butyl groups, R¹ and/or R² can both or individually be iso-amyl groups, R¹ and/or R² can both or individually be n-amyl groups, or R¹ and/or R² can be mixtures thereof (e.g., when comprising a blend of dibasic esters).

In further embodiments the invention can include blends comprising adducts of branched diacids, the adducts having the formula R³—OOC-A-COO—R⁴ wherein R³ and R⁴ are the same or different alkyl groups and A is a branched or linear hydrocarbon. Typically, A comprises an isomer of a C₄ hydrocarbon. Examples include those where R³ and/or R⁴ can be linear or branched, cyclic or noncyclic, C₁-C₂₀ alkyl, aryl, alkylaryl or arylalkyl groups. Typically, R³ and R⁴ are independently selected from the group consisting of methyl, ethyl, propyl, isopropyl, butyl, n-butyl, iso-butyl, iso-amyl, and fusel.

In yet another embodiment, the invention comprises a composition based on dicarboxylic acid diester(s) of formula R⁵—OOC-A-COO—R⁶ wherein group A represents a divalent alkylene group typically in the range of, on average, from 2.5 to 10 carbon atoms. R⁵ and R⁶ groups, which can be identical or different, represent a linear or branched, cyclic or noncyclic, C₁-C₂₀ alkyl, aryl, alkylaryl or an arylalkyl group.

The blend can correspond to a complex reaction product, where mixtures of reactants are used. For example, the reaction of a mixture of HOOC-A^{a}-COOH and HOOC-A^{b}-COON with an alcohol R^{a}—OH can give a mixture of the products R^{a}OOC-A^{a}-COOR^{a} and R^{a}OOC-A^{b}-COOR^{a}. Likewise, the reaction of HOOC-A^{a}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b} and R^{b}OOC-A^{a}-COOR^{a} (different from R^{a}OOC-A^{a}-COOR^{b} if A^{a} is not symmetrical). Likewise, the reaction of a mixture of HOOC-A^{a}-COOH and HOOC-A^{b}-COON with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b}, R^{b}OOC-A^{a}-COOR^{a} (different from R^{a}OOC-A^{a}-COOR^{b} if A^{a} is not symmetrical), R^{a}OOC-A^{b}-COOR^{a} and R^{b}OOC-A^{b}-COOR^{b}, R^{a}OOC-A^{b}-COOR^{b} and R^{b}OOC-A^{b}-COOR^{a} (different from R^{a}OOC-A^{b}-COOR^{b} if A^{b} is not symmetrical).

The groups R¹ and R², can correspond to alcohols R¹—OH and R²—OH (respectively). These groups can be likened to the alcohols. The group(s) A, can correspond to one or more dicarboxylic acid(s) HOOC-A-COOH. The group(s) A can be likened to the corresponding diacid(s) (the diacid comprises 2 more carbon atoms than the group A).

In one embodiment, group A is a divalent alkylene group comprising, on average, more than 2 carbon atoms. It can be a single group, with an integral number of carbon atoms of greater than or equal to 3, for example equal to 3 or 4. Such a single group can correspond to the use of a single acid. Typically, however, it corresponds to a mixture of groups corresponding to a mixture of compounds, at least one of which exhibits at least 3 carbon atoms. It is understood that the mixtures of groups A can correspond to mixtures of different isomeric groups comprising an identical number of carbon atoms and/or of different groups comprising different numbers of carbon atoms. The group A can comprise linear and/or branched groups.

According to one embodiment, at least a portion of the groups A corresponds to a group of formula —(CH₂)ₙ— where n is a mean number greater than or equal to 3. At least a portion of the groups A can be groups of formula —(CH₂)₄— (the corresponding acid is adipic acid). For example, A can be a group of formula —(CH₂)₄—, and/or a group of formula —(CH₂)₃—.

In one embodiment, the composition comprises compounds of formula R—OOC-A-COO—R where A is a group of formula —(CH₂)₄—, compounds of formula R—OOC-A-COO—R where A is a group of formula —(CH₂)₃—, and compounds of formula R—OOC-A-COO—R where A is a group of formula —(CH₂)₂—.

According to one embodiment, the emulsion is semi-transparent. The emulsion may have, for example, a transmittance of at least 90% and preferably of at least 95% at a wavelength of 600 nm, for example measured using a Lambda 40 UV-visible spectrometer.

According to another embodiment, the emulsion comprises a mean droplet size is greater than or equal to 0.15 μm, for example greater than 0.5 μm, or 1 μm, or 2 μm, or 10 μm, or 20 μm, and preferably less than 100 μm. The droplet size may be measured by optical microscopy and/or laser granulometry (Horiba LA-910 laser scattering analyzer).

In certain embodiments, the dibasic ester blend comprises:

a diester of formula I:

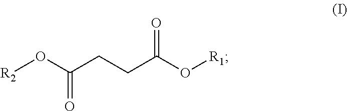

a diester of formula II:

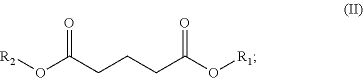

and

a diester of formula III:

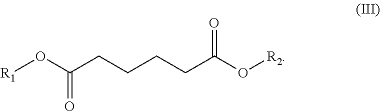

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula III, and more typically, (i) about 20% to about 28% of the diester of formula I, (ii) about 59% to about 67% of the diester of formula II, and (iii) about 9% to about 17% of the diester of formula III. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.), Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

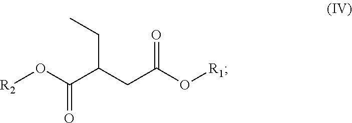

a diester of the formula V:

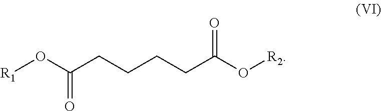

and

a diester of the formula VI:

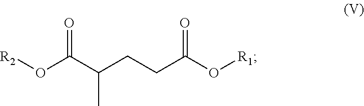

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0.5% to about 4% of the diester of formula VI.

Most typically, the blend comprises (by weight of the blend): (i) about 9% of the diester of formula IV, (ii) about 89% of the diester of formula V, and (iii) about 1% of the diester of formula VI. The blend is generally characterized by a flash point of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.).

The fatty acid alkyl esters utilized i correspond to formula:

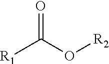

wherein R₁ and R₂ are each, individually a linear or branched hydrocarobon group containing from about 1 to about 45 carbon groups. The esters are derived from saturated and/or unsaturated fatty acids containing 1 to 45 carbon atoms and alcohols containing 1 to 15 carbon groups/atoms. Typical examples include but are not limited to methyl, ethyl, propyl, butyl and/or stearyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and the technical mixtures thereof. Cocofatty acid and/or tallow fatty acid alkyl esters can be utilized.

Fatty acid alkyl esters can be made from esterification according to known methods, for example, via esterification of fatty acids with an alcohol and an acidic catalyst. For example, beginning from natural fats and oils containing free fatty acids, fatty acid methyl esters can be obtained by first esterifying the free fatty acids present in the starting material in the presence of acidic catalysts with excess methanol or a suitable alcohol, separating an alcohol phase containing the catalyst, extracting the remaining oil phase (triglyceride phase) with a glycerol-alcohol mixture and subjecting the treated oil phase to an alkali-catalyzed transesterification with alcohol.

Any suitable fats and oils of vegetable and animal origin can used as starting material and transesterified as the triglycerides utilized, for example: rape-seed oil, soy bean oil, sunflower oil, tallow, palm oil and palm fat, castor oil, coconut oil and coconut fat, olive oil, peanut oil, safflower oil, linseed oil, purgative nut oil, cotton seed oil, rice oil, lard, among others.

In one embodiment, water can include but is not limited to tap water, filtered water, bottled water, spring water, distilled water, deionized water, and/or industrial soft water.

In another embodiment, the solvent can include organic or nonorganic solvents, including but not limited to aliphatic or acyclic hydrocarbons solvents, halogenated solvents, aromatic hydrocarbon solvents, glycol ether, a cyclic terpene, unsaturated hydrocarbon solvents, halocarbon solvents, polyols, ethers, esters of a glycol ether, alcohols including short chain alcohols, ketones or mixtures thereof.

In one embodiment, additional surfactants may be utilized. Surfactants that are useful for preparing the emulsions can be one or more anionic surfactants, cationic surfactants, non-ionic surfactants, zwitterionic surfactants, amphoteric surfactants.

In a further or alternative embodiment, additional components or additives may be added to the cleaning composition. The additional components include, but are not limited to, delaminates, buffering and/or pH control agents, fragrances, perfumes, defoamers, dyes, whiteners, brighteners, solubilizing materials, stabilizers, thickeners, corrosion inhibitors, lotions and/or mineral oils, enzymes, cloud point modifiers, preservatives, ion exchangers, chelating agents, sudsing control agents, soil removal agents, softening agents, opacifiers, inert diluents, graying inhibitors, stabilizers, polymers and the like.

Typically, additional components comprise one or more delaminates. Delaminates can be certain terpene-based derivatives that can include, but are not limited to, pinene and pinene derivatives, d-limonene, dipentene and oc-pinene.

The buffering and pH control agents include for example, organic acids, mineral acids, as well as alkali metal and alkaline earth salts of silicate, metasilicate, polysilicate, borate, carbonate, carbamate, phosphate, polyphosphate, pyrophosphates, triphosphates, ammonia, hydroxide, monoethanolamine, monopropanolamine, diethanolamine, dipropanolamine, triethanolamine, and/or 2-amino-2-methylpropanol.

More specifically, the buffering agent can be a detergent or a low molecular weight, organic or inorganic material used for maintaining the desired pH. The buffer can be alkaline, acidic or neutral, including but not limited to 2-amino-2-methyl-propanol; 2-amino-2-methyl-1,3-propanol; disodium glutamate; methyl diethanolamide; N,N-bis(2-hydroxyethyl)glycine; tris(hydroxymethyl)methyl glycine; ammonium carbamate; citric acid; acetic acid; ammonia; alkali metal carbonates; and/or alkali metal phosphates.

In still another embodiment, thickeners, when used, include, but are not limited to, cassia gum, tara gum, xanthan gum, locust beam gum, carrageenan gum, gum karaya, gum arabic, hyaluronic acids, succinoglycan, pectin, crystalline polysaccharides, branched polysaccharide, calcium carbonate, aluminum oxide, alginates, guar gum, hydroxypropyl guar gum, carboxymethyl guar gum, carboxymethylhydroxypropyl guar gum, and other modified guar gums, hydroxycelluloses, hydroxyalkyl cellulose, including hydroxyethyl cellulose, carboxymethylhydroxyethyl cellulose, hydroxypropyl cellulose, carboxymethylcellulose and/or other modified celluloses. In a further embodiment, the whiteners include, but are not limited to, percarbonates, peracids, perborates, chlorine-generating substances hydrogen peroxide, and/or hydrogen peroxide-based compounds. In another embodiment, the polymer is generally a water soluble or dispersable polymer having a weight average molecular weight of generally below 2,000,000.

Since dibasic esters are subject to hydrolysis under certain conditions, it is understood that the blend of dibasic esters can contain a minute amount of alcohol, typically a low molecular weight alcohol such as ethanol, in concentrations of about 2% to about 0.2%.

A generally contemplated composition, in one embodiment, comprises (based on the total weight of the composition) (a) from about 1% to about 99% by weight a blend of dibasic esters and (b) from about 1% to about 75% by weight one or more biodiesel components. The composition may optionally contain water or a solvent in varying amounts, depending on the desired concentration. For example, it may be desirable to have the composition as a concentrated composition for shipping, transportation purposes as well as for other cost savings. It may also be desirable to have the composition in fully diluted form.

In either concentrated or diluted form, the composition is hydrolytically stable, typically up to 6 months or greater, more typically up to 12 months or greater for the diluted form and longer in the concentrated form. The formulations, which contain the dibasic ester blends, typically, MGN blends, have hydrolysis stability, where hydrolysis/decomposition typically produces the acid form of the ester and methanol. The methanol concentration of the formulation comprising the described dibasic ester blend was monitored and shown to generally be stable, typically less than 300 ppm (parts per million), more typically less than or about 250 ppm, typically at or less than about 210 ppm. (When prior art ester-based cleaning solutions sit in an aqueous solution, the esters typically begin to decompose. The decomposing ester produces undesirable and potentially hazardous byproducts. Furthermore, as the ester decomposes, the amount of ester, which is the active ingredient in the cleaning solution, is decreasing.)

In one embodiment, the cleaning composition comprises: from about 1% to about 95% by weight a blend of dibasic esters; from about 1% to about 50% by weight one or more biodiesel components; and, optionally, water; more typically, from about 25% to about 90% by weight a blend of dibasic esters; (b) from about 1% to about 45% by weight one or more biodiesel components; and, optionally, (c) water. Optionally, additives such as fragrances and solubilizers, pH adjusting agents, whiteners, delaminates, opacifying agent, anti-corrosion agents, anti-foaming agents, coloring agents, stabilizers and thickeners can be added. The cleaning composition is typically in form of an emulsion and provided as a liquid or spray formulation for use, depending upon the application. The cleaning composition can also be provided as a liquid or spray formulation for use, depending upon the application. In another embodiment, disclosed is a method of cleaning paper processing equipment using the cleaning composition. The paper processing equipment can be for example the wire mesh, the conveyor or other equipment used in the process of converting raw pulp material into paper sheets or in the process of recycling paper and paper products.

### EXPERIMENTS

Without being bound by theory, it is believed that the cleaning composition (comprising the DBE blend and a fatty acid methyl ester) has a synergistic effect on removing material from the mesh while maintaining a lower viscosity and freezing point than pure FAME.

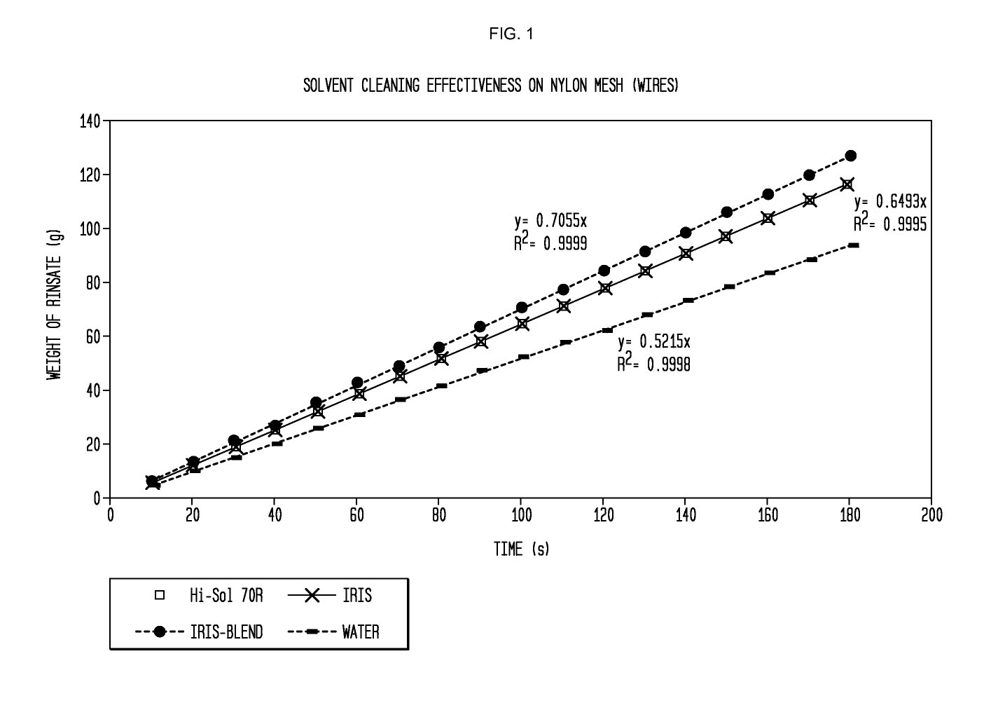

Testing was done by spraying a 4″x6″ piece of nylon mesh that was clogged during the papermaking process with 300 g of the solvent/composition (90% IRIS and 10% FAME). The sprayer was maintained at 8″ from the center of the nylon mesh which was held at a 45° angle from the spray head. The pressure was 12 psi which about a factor of 33 less than the 400 psi that is run in the paper plant. The rinsate solvent was examined for clarity/visual turbidity as shown in FIG. 1.

It was observed that cleaning with water did not remove anything significant amount, as evidenced by the clear liquid rinsate. Hi Sol 70R rinsate appeared to remove significant amounts of material, but was slightly lighter than the IRIS (neat) rinsate. The blend (90% IRIS and 10% FAME or fatty acid methyl ester) rinsate was more turbid that the IRIS rinsate.

Further testing was preformed by examining the cleaned nylon mesh for resistance to flow. This was accomplished by measuring the flow rate of a guar solution under pressure through the filter in question (See PSR Check list CRTB 06-04.1 and Filter Cleaning Evaluation for Georgia-Pacific: SOP and hazard mitigation plan). FIG. 2 shows the results of the filtration tests for the best solvents. The IRIS/FAME (90% IRIS and 10% FAME) blend shows improved results, about 9% better cleaning as shown by weight of rinsate than either the IRIS neat or the Hi Sol 70R.

The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A cleaning composition comprising:
(a) a blend of dibasic esters comprising (i) a dialkyl methylglutarate and (ii) at least one of a dialkyl adipate or a dialkyl ethylsuccinate;
(b) a biodiesel component comprising a fatty acid alkyl ester.

2. The cleaning composition of claim 1 wherein the blend of dibasic esters comprises a dialkyl adipate, a dialkyl methylglutarate and a dialkyl ethylsuccinate.

3. The cleaning composition of claim 1 wherein the blend of dibasic esters is derived from one or more by-products in the production of polyamide.

4. The cleaning composition of claim 1 wherein the blend of dibasic esters is derived from adiponitrile.

5. The composition of claim 1 wherein the blend of dibasic esters comprises from about 1% to about 99% by weight of the composition, and wherein the biodiesel component comprises from about 1% to about 65% by weight of the composition.

6. The composition of claim 5 wherein the biodiesel component comprises from about 1% to about 50% by weight of the composition.

7. The composition of claim 1 further comprising an additive selected from the group consisting of delaminates, buffering agents, fragrances, perfumes, defoamers, dyes, whiteners, brighteners, solubilizing materials, stabilizers, thickeners, corrosion inhibitors, lotions, mineral oils, enzymes, cloud point modifiers, particles, preservatives, ion exchangers, chelating agents, sudsing control agents, soil removal agents, softening agents, opacifiers, inert diluents, graying inhibitors, stabilizers, polymers and any combination thereof.

8. The composition of claim 7 wherein the additive comprises from about 0.1% to about 40% by weight of the composition.

9. The cleaning composition of claim 2 wherein the blend of dibasic esters comprises:
(i) about 7-14%, by weight of the blend, a dibasic ester of formula: 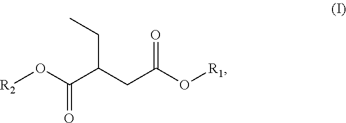
(ii) about 80-94%, by weight of the blend, a dibasic ester of formula 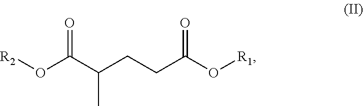
and
(iii) about 0.5-5%, by weight of the blend, a dibasic ester of formula 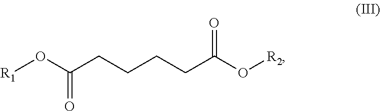
wherein R₁ and R₂ individually comprise a hydrocarbon group selected from methyl, ethyl, propyl, isopropyl, n-butyl, pentyl, isoamyl, hexyl, heptyl or octyl.

10. The cleaning composition of claim 1 wherein the blend of dibasic esters comprises:
(i) about 6-20%, by weight of the blend, a dibasic ester of formula: 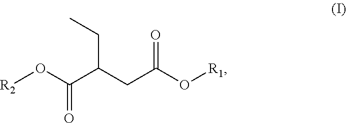
and
(ii) about 80-98%, by weight of the blend, a dibasic ester of formula 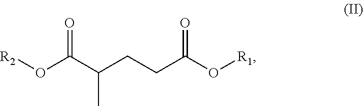
wherein R₁ and R₂ individually comprise a hydrocarbon group selected from methyl, ethyl, propyl, isopropyl, n-butyl, pentyl, isoamyl, hexyl, heptyl or octyl.

11. The cleaning composition of claim 1 wherein fatty acid alkyl ester is a fatty acid methyl ester.

12. The cleaning composition of claim 1 wherein the a fatty acid alkyl ester is selected from the group consisting of: an alkyl ester of caproic acid, an alkyl ester of caprylic acid, an alkyl ester of 2-ethylhexanoic acid, an alkyl ester of capric acid, an alkyl ester of lauric acid, an alkyl ester of isotridecanoic acid, an alkyl ester of myristic acid, an alkyl ester of palmitic acid, an alkyl ester of palmitoleic acid, an alkyl ester of stearic acid, an alkyl ester of isostearic acid, an alkyl ester of oleic acid, an alkyl ester of elaidic acid, an alkyl ester of petroselic acid, an alkyl ester of linoleic acid, an alkyl ester of linolenic acid, an alkyl ester of elaeostearic acid, an alkyl ester of arachic acid, an alkyl ester of gadoleic acid, an alkyl ester of behenic acid, an alkyl ester of erucic acid and any combination thereof; and wherein the alkyl is methyl, ethyl, propyl, butyl or stearyl.

13. A method of cleaning industrial paper and pulp processing equipment comprising:
(a) providing the cleaning composition of claim 1;
(b) contacting the cleaning composition with a surface, and
(c) removing the used cleaning composition from the cleaned surface.
